(19) United States
(12) Patent Application Publication
(10) Pub. No.: US 2012/0178370 A1
(43) Pub. Date: Jul. 12, 2012

(54) WIRELESS TERMINAL WITH SWITCHED AUXILIARY DEVICE PORT APPARATUS AND METHOD

(76) Inventor: David George, Brea, CA (US)

(21) Appl. No.: 13/228,409

(22) Filed: Sep. 8, 2011

Related U.S. Application Data
(60) Provisional application No. 61/381,003, filed on Sep. 8, 2010.

(51) Int. Cl. H04B 7/00

(52) U.S. Cl. 455/41.3

(57) ABSTRACT

A wireless terminal switched device port apparatus adapted for use in a communication system having a switching system member, a radio transceiver connector element, a wired accessory port connector element, a wireless transceiver element, and an antenna is disclosed.

This non-provisional patent application claims a benefit of priority to previously filed U.S. provisional patent application No. 61/381,003 filed Sep. 8, 2010 to George, entitled WIRELESS TERMINAL WITH SWITCHED AUXILIARY DEVICE PORT APPARATUS AND METHOD. The afore-mentioned provisional patent application is hereby incorporated by reference in its entirety as if disclosed herein in full.

### SUMMARY

In one embodiment of the present teachings, a wireless terminal switched device port apparatus adapted for use in a communication system having a wired accessory, a wireless accessory, a radio transceiver device having an external accessory connector element, is disclosed. The wireless terminal switched device port apparatus comprises a switching system member, adapted to switch communications operation between a wired communications channel and a wireless communications channel upon receipt of a switching control signal, wherein the switching system member is further adapted to provide a plurality of interface elements. The wireless terminal switched device port apparatus further comprises a radio transceiver connector element, adapted to operatively connect to the switching system member, further adapted to operatively connect to the external accessory connector element of the radio transceiver device. The wireless terminal switched device port apparatus further comprises a wired accessory port connector element, operatively connected to the switching system member, adapted to operatively connect to the wired accessory via the wired communications channel. A wireless transceiver element is operatively connected to the switching system member, adapted to operatively connect to the wireless accessory via the wireless communications channel. An antenna is electrically coupled to the wireless transceiver element, wherein the antenna is adapted to receive and transmit electromagnetic signals in the wireless communications channel.

### BRIEF DESCRIPTION OF THE DRAWINGS

Embodiments of the present disclosure will be more readily understood by reference to the following figures, in which like reference numbers and designations indicate like elements.

FIG. 1 illustrates a schematic view for a wireless terminal with switched auxiliary device port apparatus.

FIG. 2 illustrates a schematic view for a system employing a wireless terminal with switched auxiliary device port apparatus.

### DETAILED DESCRIPTION

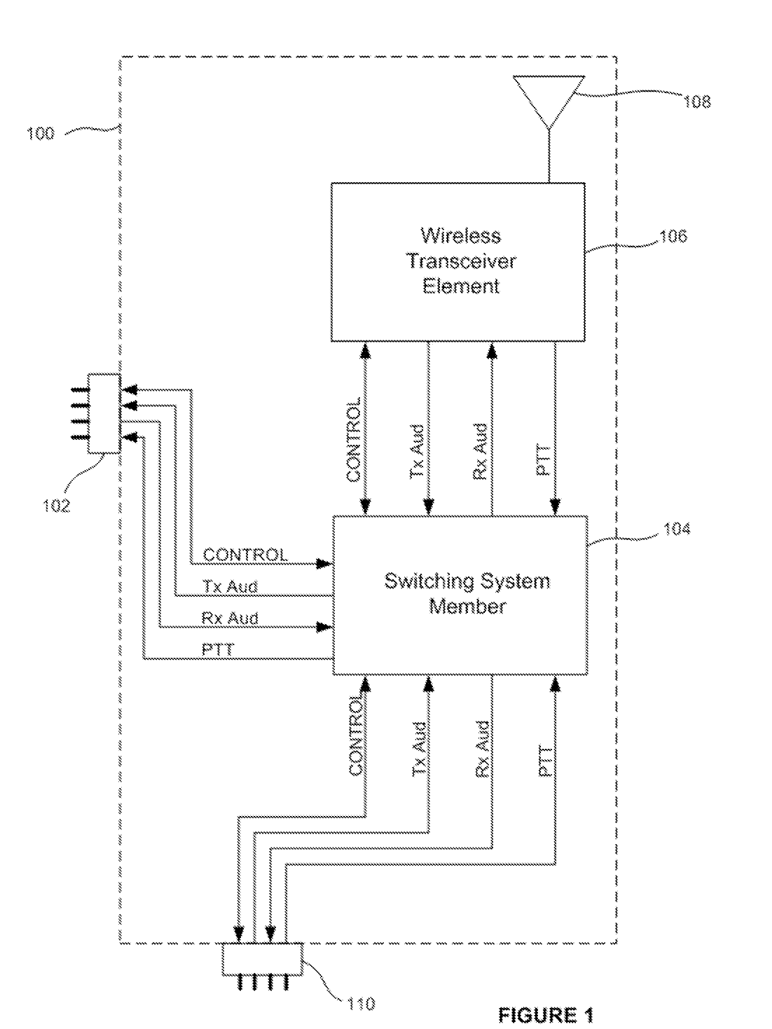

Referring now to FIG. 1, in one embodiment, a wireless terminal switched device port apparatus 100 adapted for use in a communication system is disclosed. The wireless terminal switched device port apparatus 100 comprises a switching system member 104, a radio transceiver connector element 102, a wired accessory port connector element 110, a wireless transceiver element 106, and an antenna 108.

The wireless terminal switched device port apparatus 100 comprises a switching system member 104 adapted to switch communications operation between a wired communications channel and a wireless communications channel upon receipt of a switching control signal. The switching system member 104 provides a plurality of interface elements for various communications signals, such as for example control signals or information signals. In the illustrative exemplary embodiment of FIG. 1, such communications signals include a Push-To-Talk (“PTT”) signal, a received audio signal (Rx Aud), a transmitted audio signal (Tx Aud), and a control signal (CONTROL). Such signals can be unidirectional or bidirectional. The PPT, is used in a two-way wireless transceiver that switches transmission/reception by performing FM, AM, or PM modulation using one frequency, is a transmission/reception switchover technique used by many wireless stations. For example, a user presses a PTT button during talking, and releases the PTT button during listening. In one embodiment the PTT button is wirelessly connected to the wireless terminal switched device port apparatus 100, such as for example via a Bluetooth® connection.

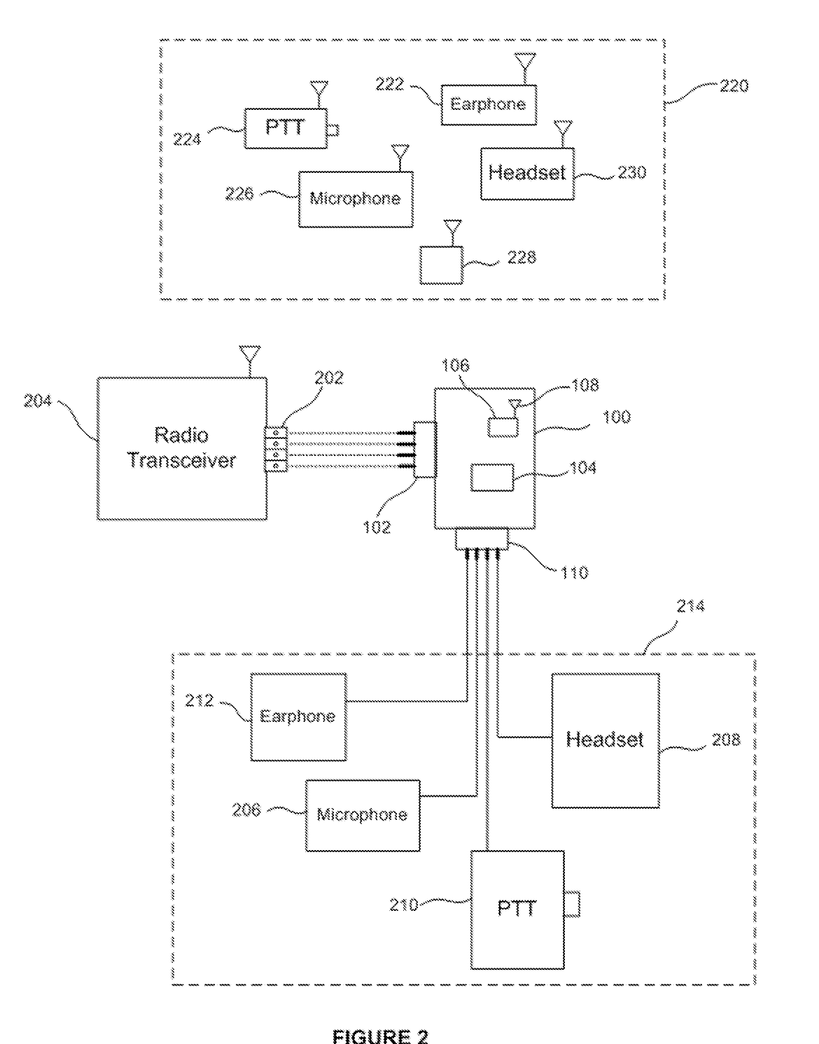

The switching system member 104 is operatively connected to the radio transceiver connector element 102. In one embodiment, the switching system member 104 is operatively coupled to the radio transceiver connector element 102 via the plurality of interface elements facilitating a bidirectional CONTROL signal path, a unidirectional transmitted audio signal path (Tx Aud), a unidirectional received audio signal path (Rx Aud), and a unidirectional PTT signal path. The bidirectional CONTROL signal path facilitates communication of one or more control signals configured to activate or deactivate distinct communications channels. The unidirectional Tx Aud signal path from the switching system member 104 to the radio transceiver connector element 102 facilitates transmission of audio signals from the wireless terminal switched device port apparatus 100 to a radio transceiver 204 through an external accessory connector element 202, as shown in FIG. 2. The radio transceiver 204 prepares the Tx Aud signal for broadcasting.

Similarly, unidirectional Rx Aud signal path from the radio transceiver connector element 102 to switching system member 104 facilitates transmission of audio from the radio transceiver 204 through the external accessory connector element 202 to the wireless terminal switched device port apparatus 100. Additional signal and/or information communication paths may optionally be included between the switching system member 104 and operatively connected to the radio transceiver connector element 102, without departing from the spirit and scope of the present teachings.

The wired accessory port connector element 110 is operatively connected to the switching system member 104. In one embodiment, the wired accessory port connector element 110 is operatively coupled to the switching system member 104 via a bidirectional CONTROL signal path, a unidirectional transmitted audio signal path (Tx Aud), a unidirectional received audio signal (Rx Aud), and a unidirectional PTT signal path, as illustrated in FIG. 1. A wired accessory 214 is optionally connected to the wired accessory port connector element 110 via a wired communications channel. Alternate embodiments of the present disclosure include a broad variety of potential wired accessories 214, which may be connected to the wired accessory port connector element 110, such as for example a wired microphone 206, a wired headset 208, a wired PTT 210, and a wired earphone 212. The wired accessories 214 listed herein are for illustrative purposes and the listed devices herein are exemplary, however additional wired devices may be configured to operatively connect to the wired accessory port connector element 110 as required by a user. Additional wired devices include devices adapted to provide input and/or output of information and/or control signals into the wired accessory port connector element 110.

The wireless transceiver element 106 is operatively connected to the switching system member 104. In one embodiment, the wireless transceiver element 106 is operatively coupled to the switching system member 104 via a bidirectional CONTROL signal path, a unidirectional transmitted audio signal path (Tx Aud), a unidirectional received audio signal (Rx Aud), and a unidirectional PTT signal path, as illustrated in FIG. 1. A plurality of interface elements facilitates this connectivity. The wireless transceiver element 106 is operatively coupled to a wireless accessory 220. A plurality of wireless accessories are available to connect to the wireless transceiver element 106, such as for example a wireless earphone 222, a wireless PTT 224, a wireless microphone 226, and/or a wireless headset 230. A wireless communications channel facilitates operative connectivity between the wireless accessory 220 and the wireless transceiver element 106. The wireless communications channel is further facilitated by an antenna 108, which is electrically coupled to the wireless transceiver element 106. The wireless accessory 220 is configured to send and/or receive information or control signals as necessary.

In one illustrative exemplary embodiment of the present teachings, a wireless communications channel is facilitated via a Bluetooth® protocol channel. Bluetooth® is a wireless protocol for exchanging data over short distances from fixed and mobile devices, which can operate to connect several devices. Bluetooth® is generally defined as a layer protocol architecture consisting of core protocols, cable replacement protocols, telephony control protocols, and adopted protocols. Bluetooth® is a popular technology for wirelessly connecting a microphone, earphone and/or speaker to a cellular telephone, music player or similar device. One more specialized device is a two-way transceiver radio. Two-way radios, specifically handheld or “Portable” radios typically have external connectors for the attachment of wired remote Microphones and Speaker (or Earphones). Many two-way radio and two-way radio accessory manufacturers are now offering devices with Bluetooth® technology that can attach to the two-way radios' external accessory connectors and allow the use of commercial headsets, earphones, etc or similar devices customized specifically for the two-way radio user needs. While a Bluetooth® device provides the convenience of wireless connectivity it cannot provide as many options for external microphone and speaker/earphone optional as what is available in a wired version. The present disclosure has solved this problem by developing an apparatus that combines the convenience of wireless (e.g., Bluetooth®) with the vast variety of wired accessories.

One embodiment of the present disclosure combines normal wireless Bluetooth® operation with a wired accessory port connector element 110 and provides this combination with mechanisms to automatically switch between the Bluetooth® and a wired accessory 214 with minimal interaction with the operator. This switching intelligence facilitates a successful combination of wireless and wired devices otherwise reliable communications can be compromised. And since two-way radios are a vital tool of Police, Fire, Military, Security and other critical operations communications reliability is paramount. In this embodiment of the present disclosure, the wireless transceiver element 106 comprises a Bluetooth® transceiver. According to one feature of Bluetooth®, one master and six slaves constitute a piconet, and an ad-hoc communication network is constructed among the devices constituting the piconet. That is, seven devices are connected to one piconet, and one among the seven devices becomes a master that manages the piconet, such as generation of a frequency hopping pattern, while the remainders serve as slaves. In the Bluetooth® embodiment of the present teachings, the wireless terminal switched device port apparatus 100 serves as the master, and the wireless accessories 220 (e.g., a wireless earphone 222, a wireless PTT 224, a wireless microphone 226, and/or a wireless headset 230) serve as the slaves. Also, according to the present disclosure, the wireless terminal switched device port apparatus 100 and the wireless headset 230 perform Bluetooth® communications using a headset profile (HSP), and the wireless terminal switched device port apparatus 100 and the wireless PTT 224 perform Bluetooth® communications using a serial port profile (SSP). Here, the Bluetooth profiles define protocol arrangements for respective applications. That is, the profiles specify methods of mounting software stacks by application appliances to secure the interoperability among Bluetooth® products from different manufacturers. In the profile, functions of Bluetooth® layers and relations between such layers and applications have been defined. In Bluetooth® version 1.0, 13 profile types have been defined, and operations for newly appropriating insufficient profiles have been steadily conducted by working groups.

### Switching Operations

Wired to Wireless

In accordance with one embodiment of the present teachings, an operation facilitating automated switching between a wired accessory 214 and a wireless accessory 220 is now disclosed. In this embodiment, a wireless terminal switched device port apparatus 100 is operatively connected to a wired accessory 214 in a wired communications channel, facilitated by the wired accessory port connector element 110. As described above, the wireless terminal switched device port apparatus 100 provides communications pathways for information and/or control signals between the wired accessory 214 and a radio transceiver 204. According to the present teachings, when a user physically disconnects the wired accessory 214 from the wired accessory port connector element 110, a disconnect control signal (“DCNTRL”) is transmitted along a control path to the switching system member 104. The switching system member 104 relays DCNTRL to a wireless transceiver element 106 (e.g., a Bluetooth® transceiver) which in turn, initiates a wireless search. In one embodiment, the wireless search activates an antenna 108, which begins searching for a wireless accessory 220 corresponding to the previously disconnected wired accessory 214. In one exemplary embodiment, if a wired headset 208 is disconnected from the wired accessory port connector element 110, the DCNTRL signal is immediately sent to the switching system member 104. The switching system member 104 then relays DCNTRL to the wireless transceiver 106, which then activates the antenna 108, thereby causing a search of a local physical region for a wireless headset 230 in operational range of a wireless communications channel (e.g., Bluetooth®). In one embodiment, employing Bluetooth® as the wireless protocol, a headset profile (HSP) is utilized as the profile to establish an operative wireless communications channel for connectivity between the wireless headset 230 and the Bluetooth® transceiver 106.

Wireless to Wired

In accordance with one embodiment of the present teachings, an operation facilitating automated switching between a wireless accessory 220 and a wired accessory 214 is now disclosed. In this embodiment, a wireless terminal switched device port apparatus 100 is operatively connected to a wireless accessory 220 in a wireless communications channel, facilitated by an antenna 108. In this exemplary embodiment, it is initially assumed that a corresponding wired accessory 214 is not physically connected to a wired port connector element 110. That is, if the wireless terminal switched device port apparatus 100 is operatively connected to a wireless accessory 220, such as for example a wireless headset 230, via a wireless communications channel (e.g., Bluetooth®) through the antenna 108, it is initially assumed that no physical connection exists between a wired headset 208 and the wired port connector element 110. However, according to the present teachings, during a time when a wireless communications channel is operatively connecting the wireless terminal switched device port apparatus 100 to the wireless headset 230, when a user does physically connect the wired headset 208 to the wired accessory port connector element 110, a connect control signal (“CCNTRL”) is transmitted along a control path to a switching system member 104. The switching system member 104 then relays CCNTRL to the wireless transceiver element 106, preparing the wireless transceiver element 106 to cease communications operations in the wireless channel, with respect to the wireless headset 230. It should be noted that in some embodiments of the present disclosure, this will not affect the wireless operation of other wireless accessories 220 operating in the wireless channel with the wireless terminal switched device port apparatus. That is, only a wired accessory 214 having a corresponding wirelessly operating accessory will be affected by this operation. Once CCNTRL prepares the wireless transceiver element 106 to cease operations, the switching system member 104 attempts to detect an operational signal on a Tx Aud signal path between the wired accessory port connector element 110 and the switching system member 104. The operational signal Tx Aud, in this embodiment, indicates that the newly connected wired accessory is functional and operational. At this point, the switching system member 104 operates to send a cease wireless operations signal, along a control signal path, to the wireless transceiver element 106, to cease operation of the corresponding wireless accessory in the wireless communications channel. However, in some embodiments, transmission of the CCNTRL signal will immediately cease the operation of the wireless accessory 220 in the wireless communications channel, while simultaneously initiating a wired communications channel between the wired accessory 214 and the wireless terminal switched device port apparatus 104.

When the wireless accessory 220 is operatively connected to the wireless terminal switched device port apparatus 100, the switching system member 104 operates to functionally connect the wireless accessory 220 to the radio transceiver connector element 102, such that the wireless accessory 220 is effectively functionally coupled to a radio transceiver 204. Hence, in one embodiment, when a wireless headset 230 is operating in the wireless communications channel, sending and receiving electromagnetic signals to and from the antenna 108, the wireless headset is effectively functionally coupled to the radio transceiver 204. When, as described in the embodiments above, the wireless channel operations cease due to a wired channel operation commencing, then the wired accessory 214 is functionally coupled to the radio transceiver 204. That is, in one embodiment, when a wired headset 208 is physically connected to the wired accessory port connector element 110, during a time when the wireless headset 230 is operating in the wireless channel, and therefore operatively coupled to the radio transceiver 204, the CCNTRL signal will initiate the termination of the wireless headset 230 operation, and initiate the operation of the wired communications channel between the wired headset 208 and the radio transceiver 204, via the wireless terminal switched device port apparatus 100. In this embodiment, the switching of the aforementioned operations will not affect operation of other wireless or wired accessories.

Firefighters often use a special type of two-way radio accessory called a throat microphone. A throat microphone picks up voice signals for the radio transmitter directly from vibrations of the larynx and not from the mouth. This system provides very clear and understandable communications when the operator is in a high ambient noise environment (sirens, fire truck engine, pumps, etc.). However once back at the station the throat microphone is no longer needed and a wireless earpiece (e.g., Bluetooth®) would be more convenient. Therefore, if the firefighter had a device using the described teachings he could simply plug in his throat microphone when he dressed to fight fire and unplug it again when he returned to the firehouse and in both cases would not have to turn off his radio or be concerned about missing any messages.

In one embodiment of the present teachings, if a wireless accessory 220 operationally fails (e.g., battery loses power), the wireless transceiver element 108 sends a NONOP control signal to the switching system member 104, wherein the switching system member 104 will attempt to connect with a corresponding wired accessory 214 physically connected to the wired accessory port connector element 110. In one exemplary embodiment, if a wireless earphone 222 is functionally connected to the wireless terminal switched device port apparatus 100 via a wireless communications channel, and the wireless earphone 222 power fails (e.g., battery fails), the wireless transceiver element 108 will detect this failure and transmit a NONOP control signal to the switching system member 104. The switching control system member 104 will attempt to detect and operationally connect to a wired earphone 212 in a wired communication channel via the wired accessory port connector element 110.

The present teachings may be practiced with other system configurations, including hand-held devices, multiprocessor systems, microprocessor-based or programmable consumer electronics, network PC's, minicomputers, mainframe computers, and the like. The present teachings may also be practiced in distributed computing environments where tasks are performed by remote processing devices that are linked through a communications network. In a distributed computing environment, program modules may be located in both local and remote memory storage devices.

The embodiments described herein above may operate in a networked environment using logical connections to one or more remote devices. These logical connections can be achieved using a communication device that is coupled to or be a part of the computer; the present teachings are not limited to a particular type of communications device. The remote device may be a computer, a microprocessor, a server, a router, a network PC, a client, a peer device or other common network node, and typically includes many or all of the elements described above. The logical connections include a local-area network (LAN) and a wide-area network (WAN). Such networking environments are commonplace in office networks, enterprise-wide computer networks, intranets and the Internet, which are all types of networks.

When used in a LAN-networking environment, the computer is connected to the local network through a network interface or adapter, which is one type of communications device. When used in a WAN-networking environment, the computer typically includes a modem, a type of communications device, or any other type of communications device for establishing communications over the wide area network, such as the Internet.

Alternative implementations are suggested, but it is impractical to list all alternative implementations of the present teachings. Therefore, the scope of the presented disclosure should be determined only by reference to the appended claims, and should not be limited by features illustrated in the foregoing description except insofar as such limitation is recited in an appended claim.

While the above description has pointed out novel features of the present disclosure as applied to various embodiments, the skilled person will understand that various omissions, substitutions, permutations, and changes in the form and details of the present teachings illustrated may be made without departing from the scope of the present teachings.

Each practical and novel combination of the elements and alternatives described hereinabove, and each practical combination of equivalents to such elements, is contemplated as an embodiment of the present teachings. Because many more element combinations are contemplated as embodiments of the present teachings than can reasonably be explicitly enumerated herein, the scope of the present teachings is properly defined by the appended claims rather than by the foregoing description. All variations coming within the meaning and range of equivalency of the various claim elements are embraced within the scope of the corresponding claim. Each claim set forth below is intended to encompass any apparatus or method that differs only insubstantially from the literal language of such claim, as long as such apparatus or method is not, in fact, an embodiment of the prior art. To this end, each described element in each claim should be construed as broadly as possible, and moreover should be understood to encompass any equivalent to such element insofar as possible without also encompassing the prior art. Furthermore, to the extent that the term “includes” is used in either the detailed description or the claims, such term is intended to be inclusive in a manner similar to the term “comprising”.

What is claimed is:

1) A wireless terminal switched device port apparatus adapted for use in a communication system having a wired accessory, a wireless accessory, a radio transceiver device having an external accessory connector element, comprising:
a) a switching system member, adapted to switch communications operation between a wired communications channel and a wireless communications channel upon receipt of a switching control signal, wherein the switching system member is further adapted to provide a plurality of interface elements;
b) a radio transceiver connector element, adapted to operatively connect to the switching system member, further adapted to operatively connect to the external accessory connector element of the radio transceiver device;
c) a wired accessory port connector element, operatively connected to the switching system member, adapted to operatively connect to the wired accessory via the wired communications channel;
d) a wireless transceiver element, operatively connected to the switching system member, adapted to operatively connect to the wireless accessory via the wireless communications channel, and;
e) an antenna, electrically coupled to the wireless transceiver element, wherein the antenna is adapted to receive and transmit electromagnetic signals in the wireless communications channel.

2) The wireless terminal switched device port apparatus of claim 1, wherein the wired accessory is selected from the group consisting of: a headset, an earphone, a microphone, and a push-to-talk device.

3) The wireless terminal switched device port apparatus of claim 2, wherein the wireless transceiver element is a Bluetooth® device.

4) The wireless terminal switched device port apparatus of claim 2, wherein the switching system member is controlled by a switching control signal of the wired accessory.

5) The wireless terminal switched device port apparatus of claim 3, wherein the switching system member is controlled by a switching control signal of the wired accessory.

6) The wireless terminal switched device port apparatus of claim 1, further adapted to detect when the wireless accessory fails to function properly, wherein the switching system member is configured to automatically switch from the wireless communications channel to the wired communications channel.

7) The wireless terminal switched device port apparatus of claim 4, further adapted to detect when the wireless accessory fails to function properly, wherein the switching system member is configured to automatically switch from the wireless communications channel to the wired communications channel.

8) The wireless terminal switched device port apparatus of claim 6, further adapted to detect when the Bluetooth® device fails to function properly, wherein the switching system member is configured to automatically switch from the wireless communications channel to the wired communications channel.

9) A wireless terminal switched device port means adapted for use in a communication system having a wired accessory, a wireless accessory, a radio transceiver device having an external accessory connector element, comprising:
a) a switching system means for switching communications operation between a wired communications channel and a wireless communications channel upon receipt of a switching control signal, wherein the switching system means is adapted to provide a plurality of interface means;
b) a radio transceiver means for operatively connecting to the switching system means, adapted to operatively connect to the external accessory connector element of the radio transceiver means;
c) a wired accessory port connector means for operatively connecting to the switching system means, adapted to operatively connect to the wired accessory means via the wired communications channel;
d) a wireless transceiver means for operatively connecting to the switching system means, adapted to operatively connect to the wireless accessory means via the wireless communications channel, and;
e) an antenna means for electrically coupling to the wireless transceiver means, wherein the antenna means is adapted to receive and transmit electromagnetic signals in the wireless communications channel.

10) A wireless PTT apparatus, adapted to activate a wireless terminal switched device port apparatus, comprising:
a) a PTT switch element, operatively coupled to the wireless PTT apparatus, adapted to actuate the wireless PTT apparatus;
b) a PTT wireless communications channel, operatively coupling the wireless PTT apparatus to the wireless terminal switched device port apparatus.

11) The wireless PTT apparatus of claim 10, further adapted to transmit a PTT signal from the wireless PTT apparatus to the wireless terminal switched device port apparatus in the PTT wireless communications channel.
